(19) United States
(12) Patent Application Publication
(10) Pub. No.: US 2025/0206594 A1
(43) Pub. Date: Jun. 26, 2025

(54) SADDLES

(71) Applicants: David KEMPSELL, Kingston, Canterbury Kent (GB); Margaret WHITE, Kingston, Canterbury Kent (GB)

(72) Inventors: David KEMPSELL, Kingston, Canterbury Kent (GB); Margaret WHITE, Kingston, Canterbury Kent (GB)

(21) Appl. No.: 18/860,680

(22) PCT Filed: Apr. 28, 2023
(86) PCT No.: PCT/EP2023/061266

§ 371 Date: Oct. 27, 2024

(30) Foreign Application Priority Data
Apr. 28, 2022 (GB) 2206249.1

(51) Int. Cl. B68C 1/02; B68C 1/04

(52) U.S. Cl. CPC B68C 1/025; B68C 1/04

(57) ABSTRACT

The present invention relates to improvements in the area of a saddle's seat directly under the rider's seat bones and the ability to adjust the seat's balance laterally for asymmetry in the rider's pelvis and therefore balance. We describe an anatomically adjustable saddle tree and seat for the ridden horse. We describe a saddle comprising a saddle tree having a lateral slot towards a rear edge thereof, a seat supported by the saddle tree, and a correction member between the saddle tree and the seat. We also describe a correction member for a saddle seat. The correction member has the form of a paddle, having a generally egg-shaped or ovoid head and a handle portion. The handle portion may be adjustable for length.

The present invention relates to saddles, in particular to seats of saddles such as for horse riding. More particularly, the present invention provides improvements in the area of a saddle's seat directly under the rider's seat bones and the ability to adjust the seat's balance laterally for asymmetry in the rider's pelvis and therefore balance. We describe an anatomically adjustable saddle tree and seat for the ridden horse.

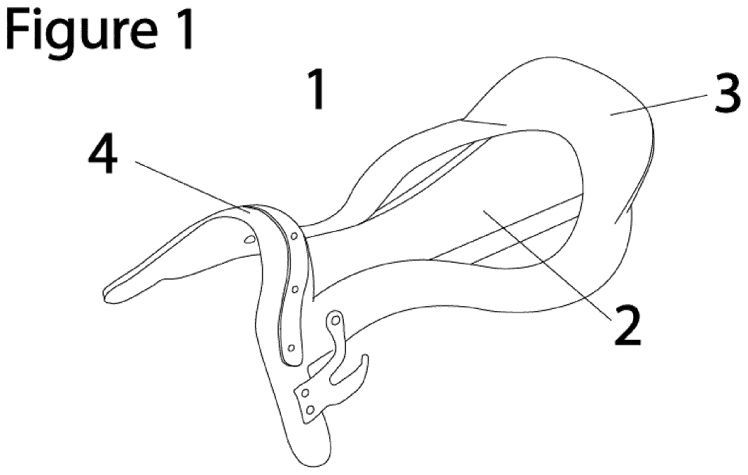

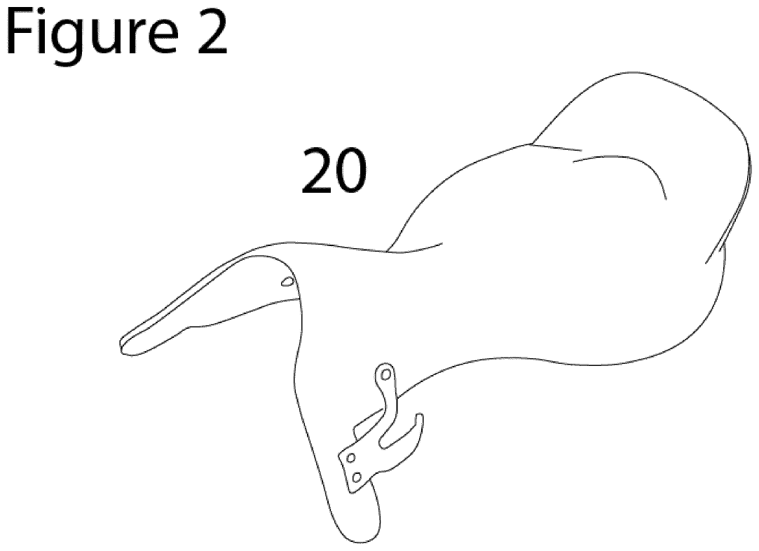

There are two conventional ways in which to construct the seat of a saddle. In the first method, as shown in FIG. 1, a framed tree with a tear drop shaped open frame 1 is forming, in which webbing is strung across the opening 2 longitudinally from the pommel 4 to the cantle 3 and laterally across the frame and longitudinal webbing to form the shape of the seat. Padding, normally in the form of a thin foam, is placed over this construction and leatherwork applied to provide a resilient finish to the saddle. With modification to the tree, the present invention can be used with this form of saddle construction. In the second conventional method, illustrated in FIG. 2, a solid tree 20, which has no opening under the rider and offers a smooth slightly curved surface under the rider, provides a structure onto which foam is affixed directly, with leatherwork thereover as a resilient finish to the saddle. This form of construct is directly suitable for the present invention.

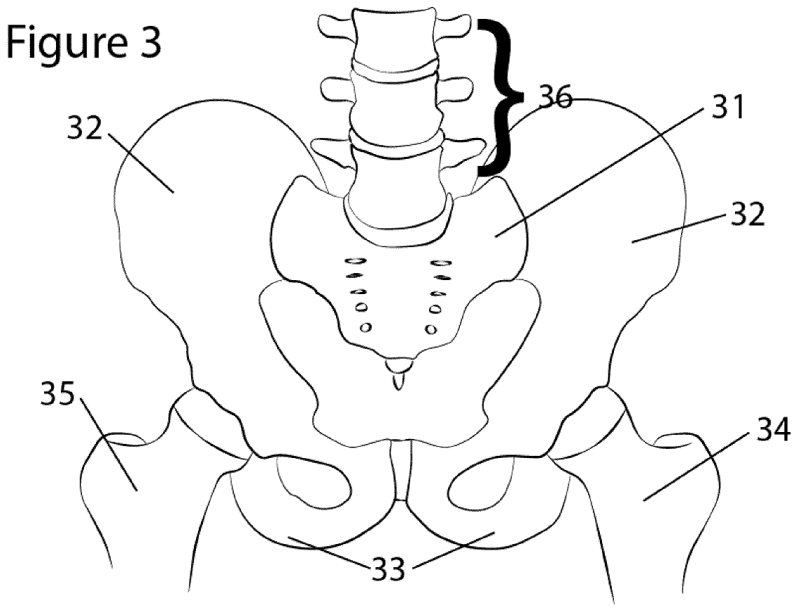

All humans exhibit asymmetry in their bodies, but this is particularly relevant when we take the sport of horse riding. The human's asymmetry over time is transferred to the musculature of the ridden equine because the load, the rider, does not sit straight and even on a saddle. There is always a bias to the left or the right. This bias predominantly arises from a difference in leg length between the left and right legs. It is perfectly normal for a human to have up to 15 mm difference in leg length. This would manifest itself as a limp if it were not compensated for whilst the human is growing into an adult. The rider's pelvis adapts to take up the difference in the leg length between left and right legs and this results in the bias to the left or right when sitting on a saddle. This is explained with reference to FIG. 3. The pelvis 30 is formed of 3 bones, the sacroiliac 31 and the left ilium and right Ilium 32. When one leg is longer than the other, the relationship of the Ilium 32 to sacroiliac 31 and to the opposing Ilium 32 is changed, causing a rotation of that Ilium 32 with the longest leg, rotating it upwards and forwards. This rotation raises the hip joint 34 or 35 and therefore shortens the functional length of the longer leg. In this way, the human does not limp or load one leg more than the other, which would be the case without the pelvis 30 adaptation. In this way the sacroiliac 31 supports the spine column in a straighter fashion and the human exhibits less spinal twist or scoliosis. This adaptation is done by the body in its formative years.

When the human sits on a horse, this pelvic compensation does not compliment sitting straight on a horse. When we sit on a horse, the human's seat bones or ischial tuberosity 33 will not be level or aligned. They will be naturally misaligned to compensate for the leg length difference when in a standing position keeping the body or trunk straight. The mounted rider's legs, being in the in the stirrups of the saddle, have no influence on upper body balance. It is the seat bones on which the rider balances and these are not level. In the case of a rider with a longer right leg, the right Ilium 32 will be rotated upward and forward, which moves the right seat bone 33 more forward on the seat of the saddle than the left. The right seat bone will lack support, being higher than the left, which will cause the pelvis to slump to the right, seeking the support of the saddle's seat. This will cause the centre of force of the rider to be shifted from centre to the right. The horse is then loaded unevenly, which will immediately alter gaits in the horse and its ability to bend through the body as well on one rein to the other. This becomes particularly important when we assess a horse performing dressage, gymnastics for horses. The objective of the sport is to demonstrate the horse's ability to perform gymnastic ridden movement in the same supple and rhythmical manner on both reins. This is not easily achieved when the rider is not loading the horse evenly.

There is also a welfare issue with this uneven loading, as it will affect the wear and tear the rider exerts on the horse joints and muscles. Sitting on a horse, we are expecting that horse to carry up to 15% of its body weight as an additional load (the rider plus the saddle) and then perform gymnastic movements. That can be likened to a human gymnast weighing 70 kg performing whilst carrying a rucksack of over 10 kg on their back! One can imagine the awkwardness of movement and strain this would create, especially if the additional load were not evenly and securely positioned.

The present invention aims to overcome these problems.

More specifically, the present invention provides, in one aspect, a saddle comprising a saddle tree having a lateral slot towards a rear edge thereof, a seat supported by the saddle tree, and a correction member between the saddle tree and the seat.

In some examples, the saddle includes a pocket between the saddle tree and the seat into which the correction member is received.

In a second aspect, the present invention provides a saddle seat comprising a saddle tree and a seat component, wherein a pocket is formed between the saddle tree and the seat component, the saddle tree includes a lateral slot towards a read edge thereof, and a correction member is at least partially located in the pocket.

Preferably, the correction member is in the form of a paddle.

Suitably, the paddle has a generally egg-shaped or ovoid head and a handle portion.

Advantageously, the handle portion is adjustable for length. Optionally, the handle portion is adjustable for length by means of a series of frangible features, further optionally a series of lateral notches. Alternatively, the handle portion is adjustable for length by a cutting or sawing procedure.

Preferably, the correction member is substantially planar and has a thickness of from 1 mm to 6 mm.

In some examples, the correction member is formed of a plurality of substantially planar correction member elements.

In a third aspect, the present invention provides a correction member for a saddle seat, the correction member being in the form of a paddle, having a generally egg-shaped or ovoid head and a handle portion.

Advantageously, the handle portion is adjustable for length, optionally by means of a series of frangible features, further optionally a series of lateral notches.

Preferably, the correction member is substantially planar and has a thickness of from 1 mm to 6 mm.

In some examples, the correction member comprises a plurality of substantially planar correction member elements.

In a fourth aspect, the present invention provides a method of improving rider load distribution in a saddle, the method comprising the step of inserting a correction member as defined above a saddle tree and a saddle seat of the saddle.

The above and other aspects of the present invention will now be described in further detail, by way of example only, with reference to the accompanying figures, in which:

FIG. 1 illustrates a traditional saddle tree for seat construction using webbing to close the opening in the tree to form a seat;

FIG. 2 illustrates a solid or closed tree of an embodiment of a saddle in accordance with the present invention;

FIG. 3 is a diagram of a human pelvis;

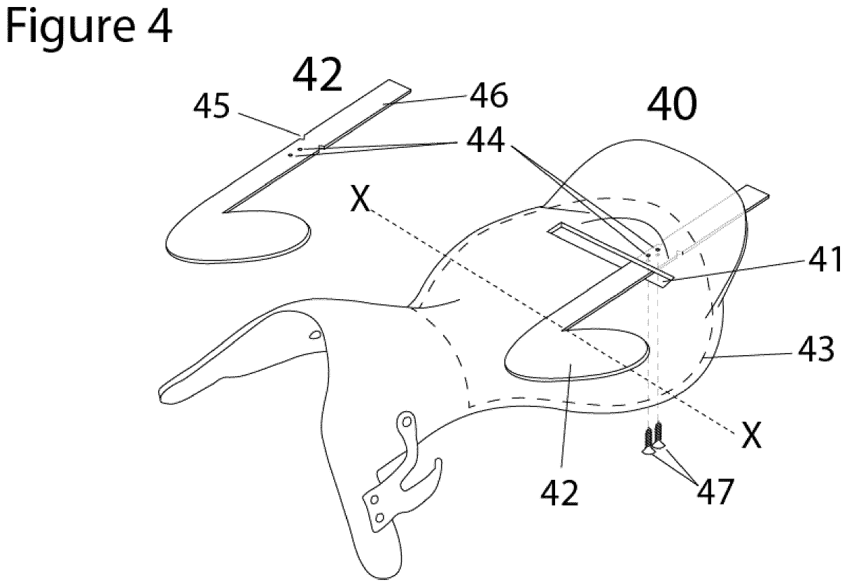

FIG. 4 illustrates an embodiment of a seat in accordance with the present invention; and

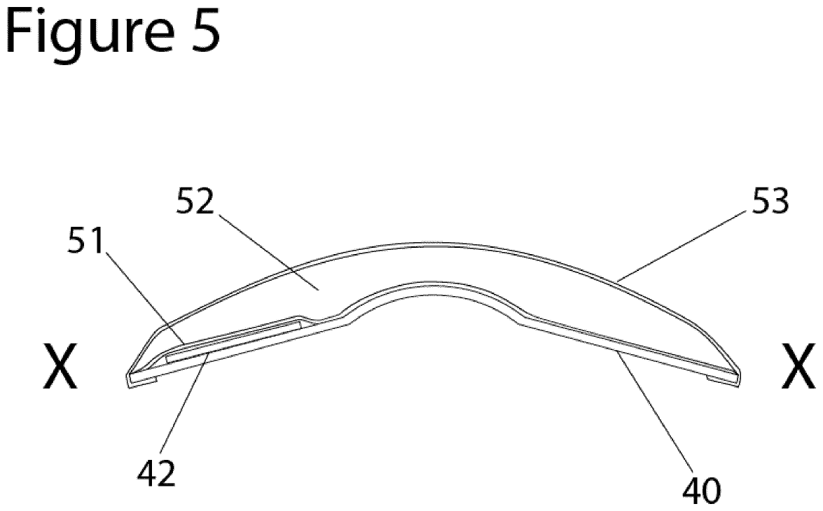

FIG. 5 is a cross section along line X-X of FIG. 4.

Accordingly, with reference to the accompanying FIGS. 2, 4 and 5, an embodiment of a saddle in accordance with the present invention includes a saddle seat formed by a saddle tree 40 with a correction member, typically in the form of a paddle 42. The saddle tree 40 includes a lateral slot 41 and a pocket 51 into which paddle 42, of the appropriate thickness, is inserted and secured in place, for example by two wood type screws 47, to provide a means of laterally balancing the rider in the saddle whilst riding.

In a general sense, the present invention provides a means of shimming or building up a saddle's seat to compensate for uneven positioning of the rider's seat bones 33 by the use of paddle 42, which can be inserted between the tree 40 of the saddle and the seat foam 52 upon it.

The thickness of the paddles 42 is selected dependent on the rider's particular need. The paddle 42 is suitably made of a material which is flexible enough to be inserted into the pocket 51 but which would not crush under pressure from the rider's seat bones. Polypropylene has been determined to be a particularly suitable material for the task and is readily available in a variety of thicknesses.

The paddle 42 is insertable into pocket 51 from underneath the seat via lateral slot 41, positioned towards the back of the saddle tree. To facilitate the insertion, the paddle 42 includes an elongate element forming a handle 46.

Any part of handle 46 which extends, once installed, outwardly from slot 41 can be removed, for example by cutting, once the required adjustment has been achieved. Conveniently, this is facilitated by notches 45 in the paddle handle 46 which can be scored with a knife and snapped.

The location for the slot 41 is in a clear space underneath the tree 40 where the tree remains visible on all saddles.

The slot 41 allows the paddle 42 to pass through the tree 40 and under the foam 52 of the seat. To ensure that seat foam 52 is not damaged when inserting the paddle 42, pocket 51 is created before foaming the seat, typically using a synthetic fibrous material similar to leather but preferably harder wearing and less stretchy, with a thickness of around 2-3 mm. The material takes adhesive well and will therefore bond the foam 52 securely in place. The size of the pocket covers an area 43 of the tree 40 to give sufficient room to manoeuvre the paddle 42 into position on one side of the seat to provide a balance for the unbalanced pelvis of the rider.

For accuracy of placement, the paddle has two holes 44 which align with corresponding holes on the underside of the tree into which two screws are placed to ensure secure and continued placement of the paddle. Any portion of handle 46 extending from the seat is then removed as described above.

The paddle 42 can be 2 mm, 3 mm, 4 mm, 5 mm or 6 mm in thickness or may be formed as a combination of paddles, such as 2×2 mm, or 3 mm+2 mm. Such an arrangement may well prove to perform better than a thicker piece of material that will not form so well to the surface of the tree 40 it sits against. The thickness of paddle 42 is not limited to these measurements but our trials have shown that 6 mm or less of compensation is sufficient for all riders. A thickness of about 3 mm has been determined to be normally sufficient to achieve excellent results. The paddle typically has, but does not need to have, a uniform thickness across its area.

In the embodiment illustrated, the paddle has a generally egg-shaped or ovoid head attached to handle 46. The head shape compliments the ischial tuberosity's 33 aspect in relation to the tree 40.

It has a size sufficient to cover the area of various builds and body shapes, sizes and gender that are likely to sit in the saddle.

A note as to gender-male and female seat bones 33 generally differ in that a woman will have seat bones wider apart than a man and therefore, they will sit in different positions on the seat The back two thirds of a saddle are triangular in appearance, narrowing as you move forward towards the pommel of the saddle. Where one sits on the triangle is to some extent dependent on the distance between one's seat bones-the wider they are apart the more to the rear of the seat the rider will sit, the narrow the distance the more forward the rider will sit. Therefore, the paddle 42 is shaped to cover all possibilities of seat bone placement.

Using state of the art pressure testing equipment combined with gait analysis of the ridden horse, it has been proven that rider balance has a great effect on a horse's mobility and athleticism. We have shown that adaptation of the saddle's seat to compensate for the difference in aspect of the seat bones 33 of a rider produces a positive outcome for the horse and the rider.

Compensation provides the rider with a more secure seat and better “contact” with the horse. A skilled horse rider uses their weight to communicate what they wish the horse to do. This is what we mean by the word “contact”. In the case of the rider described previously, the right seat bone lacks support and drops the rider's weight to the right. There is a bias of weight to the right that the horse must react to and carry. It will therefore curl its body to the right and will be less able to curl well to the left. By using compensation under the rider's seat bone in the seat of the saddle, weight distribution becomes more even and this leads to better contact and, consequently, allows to horse to maintain a straighter posture.

The horse benefits from the more even distribution of weight and becomes more supple on both reins. The horse will muscle better throughout the body due to the even loading and will in turn be less liable to lameness due to over-stressing one side to the other.

1. A saddle comprising a saddle tree having a lateral slot towards a rear edge thereof, a seat supported by the saddle tree, and a correction member between the saddle tree and the seat.

2. A saddle as claimed in claim 1 wherein the correction member is in the form of a paddle.

3. A saddle as claimed in claim 2 wherein the paddle has a generally egg-shaped or ovoid head and a handle portion.

4. A saddle as claimed in claim 3 wherein the handle portion is adjustable for length.

5. A saddle as claimed in claim 4 wherein the handle portion is adjustable for length by means of a series of frangible features.

6. A saddle as claimed in claim 1 wherein the correction member is substantially planar and has a thickness of from 1 mm to 6 mm, from 1.5 mm to 5 mm, from 2 mm to 4 mm, or about 3 mm.

7. A saddle as claimed in claim 1 wherein the correction member is formed of a plurality of correction member elements.

8. A saddle as claimed in claim 1 wherein the saddle includes a pocket between the saddle tree and the seat into which the correction member is received.

9. A saddle seat comprising a saddle tree and a seat component, wherein a pocket is formed between the saddle tree and the seat component, the saddle tree includes a lateral slot towards a rear edge thereof, and a correction member is at least partially located in the pocket.

10. A saddle seat as claimed in claim 9 wherein the correction member is in the form of a paddle.

11. A saddle seat as claimed in claim 10 wherein the paddle has a generally egg-shaped or ovoid head and a handle portion.

12. A saddle seat as claimed in claim 11 wherein the handle portion is adjustable for length.

13. A saddle seat as claimed in claim 12 wherein the handle portion is adjustable for length by means of a series of frangible features.

14. A saddle seat as claimed in claim 9 wherein the correction member is substantially planar and has a thickness of from 1 mm to 6 mm, from 1.5 mm to 5 mm, from 2 mm to 4 mm, or about 3 mm.

15. A saddle seat as claimed in claim 9 wherein the correction member is formed of a plurality of correction member elements.

16. A correction member for a saddle seat, the correction member being in the form of a paddle, having a generally egg-shaped or ovoid head and a handle portion.

17. A correction member as claimed in claim 16 wherein the handle portion is adjustable for length.

18. A correction member as claimed in claim 17 wherein the handle portion is adjustable for length by means of a series of frangible features.

19. A correction member as claimed in claim 16 wherein the correction member is substantially planar and has a thickness of from 1 mm to 6 mm, from 1.5 mm to 5 mm, from 2 mm to 4 mm, or about 3 mm.

20. A correction member as claimed in claim 16 wherein the correction member is formed of a plurality of substantially planar correction member elements.

21. A method of improving rider load distribution in a saddle, the method comprising the step of inserting a correction member as claimed in claim 16 between a saddle tree and a saddle seat of the saddle.
